(19) United States
(12) Patent Application Publication
(10) Pub. No.: US 2012/0035314 A1
(43) Pub. Date: Feb. 9, 2012

(54) Use of Protective Colloid-Stabilized Polymerizates as Low-Profile Additive (LPA)

(75) Inventors: Abdulmajid Hashemzadeh, Burgkirchen (DE); Rene Gräwe, Landshut (DE)

(73) Assignee: Wacker Chemie AG, Munich (DE)

(21) Appl. No.: 13/258,916

(22) PCT Filed: Mar. 12, 2010
(86) PCT No.: PCT/EP2010/053154

§ 371 Date: Oct. 24, 2011

(30) Foreign Application Priority Data
Mar. 24, 2009 (DE) 10 2009 001 818.2

(51) Int. Cl. C08L 33/02; C08L 31/04

(52) U.S. Cl. 524/522; 524/524

(57) ABSTRACT

The invention relates to the use of protective colloid-stabilized polymerizates as low profile additive (LPA), characterized in that the protective colloids carry one or more functional group selected from the group comprising carboxyl, sulfate, sulfonate, phosphate, phosphonate, hydroxyl and nitrogen-functional groups, having the stipulation that the mass fraction of the hydroxyl groups equals ≦10 wt % based on the total mass of a protective colloid.

### CROSS REFERENCE TO RELATED APPLICATIONS

This application is the national phase filing of international patent application No. PCT/EP2010/053154, filed 12 Mar. 2010, and claims priority of German patent application number 10 2009 001 818.2, filed 24 Mar. 2009, the entireties of which applications are incorporated herein by reference.

### FIELD OF THE INVENTION

The invention relates to the use of protective colloid-stabilized polymers as low-profile additives (LPAs), to radically crosslinkable polymer compositions comprising the aforesaid low-profile additives, and to the composite components obtainable therefrom.

### BACKGROUND OF THE INVENTION

Composite components are frequently produced using radically crosslinkable polymer compositions based on, for example, unsaturated polyester resins (UP resins). Unsaturated polyester resins are obtainable by polycondensation of dicarboxylic acids or dicarboxylic anhydrides with polyols. The radically crosslinkable polymer compositions further comprise monomers having ethylenically unsaturated groups, generally styrene. Styrene is added to the radically crosslinkable polymer composition, for example, in order to dissolve the crosslinkable polymer and in order to ensure that the radically crosslinkable polymer composition is a fluid material. As further constituents, the radically crosslinkable polymer compositions often also comprise fiber materials such as glass fibers, carbon fibers or corresponding fiber mats (Fiber Reinforced Plastic composites; FPR composites), which lead to reinforcement of the composite components obtainable by curing the radically crosslinkable polymer compositions.

A problem associated with the processing of such radically crosslinkable polymer compositions to composite components is the volume contraction during the curing of the polymer composition. In order to reduce the shrinkage on curing, therefore, the radically crosslinkable polymer compositions are admixed with what are called low-profile additives (LPAs). Low-profile additives reduce the shrinkage on curing, dissipate intrinsic stresses, reduce micro-cracking, and facilitate compliance with manufacturing tolerances. The LPAs are typically thermoplastic homopolymers or copolymers of styrene, methyl methacrylate or vinyl acetate, present in the form of solid resins. Thus, for example, U.S. Pat. No. 3,718,714 or DE-A 102006019686 recommends copolymers based on vinyl acetate and ethylenically unsaturated carboxylic acids as LPAs for the production of composite components. EP-A 0075765 recommends, as LPAs, polymers based on vinyl acetate and/or alkyl acrylates, which further comprise ethylenically unsaturated fatty acid esters.

Although the vinyl ester copolymers hitherto commonplace as LPAs do bring about, advantageously, a large antishrinkage effect in the majority of cases, in comparison to polystyrene methacrylate and to polymethyl methacrylate, they are nevertheless unsatisfactory in terms of pigmentability. Effective pigmentability means that the curing of radically crosslinkable polymer compositions comprising pigments produces composite components having a uniform colored appearance; in other words, the pigments are distributed uniformly therein. In contrast, in the case of poor pigmentability, the pigments are not uniformly distributed in the composite components, and an effect referred to as marbling occurs.

EP-A 0337931 describes LPAs in the form of water-redispersible, polyvinyl alcohol-stabilized polymer powders based on vinyl acetate-Versatic acid copolymers for the production of composite components at low temperatures. In the styrene typically present in radically crosslinkable polymer compositions, however, polyvinyl alcohol has a poor solubility. Furthermore, LPAs containing polyvinyl alcohol give the composite components produced therewith hydrophilic properties, and this has negative consequences for the aging resistance of the composite components.

In order to allow the LPAs to display their effect in the radically crosslinkable polymer compositions, the LPAs must be present in a homogeneous form therein. Deleteriously, the dissolution of the existing LPAs in the form of resin solids or in polymer powder stabilized with polyvinyl alcohol takes a very long time. Consequently, the LPAs are commonly first homogenized in styrene and then introduced in that form into the radically crosslinkable polymer compositions. This procedure therefore necessitates an additional, time-consuming step. Another problem is the storage of the LPA-containing styrenic solutions, since solutions of this kind have a tendency toward uncontrolled polymerization, and, additionally, measures must be taken to prevent the premature polymerization.

### SUMMARY OF THE INVENTION

Against this background, the object was to provide low-profile additives (LPAs) which can be rapidly dissolved or dispersed in the form of solids in at least one of the components of the radically crosslinkable polymer compositions, and which, when used for producing composite components, result in a large antishrinkage effect and an effective pigmentability, without adversely affecting the aging resistance of the composite components.

The invention provides for the use of protective colloid-stabilized polymers as low-profile additives (LPAs), characterized in that the protective colloids carry one or more functional groups selected from the group encompassing carboxyl, sulfate, sulfonate, phosphate, phosphonate, hydroxyl and nitrogen functional groups, with the proviso that the mass fraction of the hydroxyl groups is ≦10% by weight, based on the total mass of a protective colloid.

### DETAILED DESCRIPTION OF THE INVENTION

The protective colloids are obtainable, for example, by radically initiated polymerization of

a) one or more ethylenically unsaturated monomers having one or more additional functional groups selected from the group encompassing carboxyl, sulfate, sulfonate, phosphate, phosphonate, hydroxyl and nitrogen functional groups (functional monomers), and optionally
b) one or more ethylenically unsaturated monomers different from the monomers a).

Examples of monomers a) are ethylenically unsaturated carboxylic acids or salts thereof, preferably acrylic acid, methacrylic acid, crotonic acid, itaconic acid, and fumaric acid, maleic acid; monoesters of fumaric acid or maleic acid or salts thereof, such as the ethyl and isopropyl esters; ethylenically unsaturated sulfonic acids or salts thereof, preferably vinylsulfonic acid, 2-acrylamido-2-methylpropane-sulfonic acid; ethylenically unsaturated phosphonic acids or salts thereof, preferably vinylphosphonic acid.

Particularly preferred monomers a) are ethylenically unsaturated monocarboxylic or dicarboxylic acids having 2 to 15 C atoms, more particularly 2 to 10 C atoms; most preferred are acrylic acid and methacrylic acid.

For preparing the protective colloids, the monomers a) are used preferably at 2% to 20%, more preferably at 5% to 15%, and most preferably 8% to 12%, by weight, based in each case on the total mass of the monomers employed overall for preparing the protective colloids.

Preferred monomers b) are selected from the group encompassing vinyl esters of carboxylic acids having 1 to 15 C atoms, methacrylic esters or acrylic esters of carboxylic acids with unbranched or branched alcohols having 1 to 15 C atoms, vinylaromatics, vinyl halides, dienes, and non-ethylene olefins.

Suitable vinyl esters are, for example, vinyl acetate, vinyl propionate, vinyl butyrate, vinyl 2-ethylhexanoate, vinyl laurate, 1-methylvinyl acetate, vinyl pivalate, and vinyl esters of alpha-branched monocarboxylic acids having 5 to 13 C atoms, as for example VeoVa9R, VeoVa10R, or VeoVa11R (trade names of Shell).

Suitable methacrylic esters or acrylic esters are, for example, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, norbornyl acrylate, hydroxyethyl acrylate.

Suitable dienes or non-ethylene olefins are, for example, propylene and 1,3-butadiene. Suitable vinylaromatics are, for example, styrene and vinyltoluene. A suitable vinyl halide is, for example, vinyl chloride.

The monomers b) are used preferably at 75% to 98%, more preferably at 80% to 95%, and most preferably 85% to 92%, by weight, based in each case on the total mass of the monomers employed overall for preparing the protective colloids.

When two or more monomers b) are used, it is preferred to use at least one

monomer b1) selected from the group encompassing butyl acrylate, butyl methacrylate, 2-ethylhexyl acrylate and vinyl esters of alpha-branched monocarboxylic acids having 5 to 13 C atoms, as for example VeoVa10R or VeoVa11R (trade names of Shell), and at least one
monomer b2) selected from the group encompassing methyl acrylate, methyl methacrylate, styrene, and methylstyrene.

One preferred monomer b1) is butyl acrylate. Preferred monomers b2) are methyl acrylate and methyl methacrylate.

The monomers b1) are used preferably at 10% to 65%, more preferably at 20% to 50%, and most preferably at 35% to 45%, by weight, based in each case on the total mass of the monomers employed overall for preparing the protective colloids.

The monomers b2) are used preferably at 15% to 88%, more preferably at 30% to 70%, and most preferably at 45% to 55%, by weight, based in each case on the total mass of the monomers employed overall for preparing the protective colloids.

Preference is given to protective colloids based on

a) one or more monomers selected from the group encompassing acrylic acid, methacrylic acid, crotonic acid, itaconic acid and fumaric acid and maleic acid,
b1) one or more monomers selected from the group encompassing butyl acrylate, butyl methacrylate, 2-ethylhexyl acrylate, and vinyl esters of alpha-branched monocarboxylic acids having 5 to 13 C atoms, as for example VeoVa9R or VeoVa10R (trade names of Shell), and
b2) one or more monomers selected from the group encompassing methyl acrylate, methyl methacrylate, styrene, and methylstyrene.

Protective colloids comprising monomer units b1) and b2) have particularly advantageous solubility properties and lead to composite components having particularly advantageous mechanical properties.

The protective colloids preferably have glass transition temperatures Tg of at least 25° C., more preferably of 50 to 150° C., and most preferably of 50 to 100° C. The protective colloids preferably have a water solubility of ≧10 g/l. With particular preference the protective colloids at pH levels of 7.5 to 12 have a water solubility of ≧10 g/l. The solubility of the protective colloids in reactive monomers, more particularly styrene, is preferably ≧10 g/l at temperatures of 20 to 150° C.

The polymers of the protective colloid-stabilized polymers (base polymers) can be obtained by radically initiated polymerization of

one or more ethylenically unsaturated monomers c) selected from the group encompassing vinyl esters of carboxylic acids having 1 to 15 C atoms, methacrylic esters or acrylic esters of carboxylic acids with unbranched or branched alcohols having 1 to 15 C atoms, vinylaromatics, vinyl halides, dienes, and olefins.

Suitable monomers c) are for example the same monomers listed as suitable for the monomers b). Preferred monomers c) are vinyl acetate, VeoVa10R, VeoVa11R (trade names of Shell), methyl acrylate, methyl methacrylate, n-butyl acrylate, 2-ethylhexyl acrylate, styrene, and ethylene. Most preferred is vinyl acetate.

If desired it is also possible for 0.05% to 5%, preferably 1% to 2%, by weight, based on the total weight of the base polymers, of auxiliary monomers to be copolymerized. Examples of auxiliary monomers are ethylenically unsaturated carboxylic acids, preferably acrylic acid, methacrylic acid, crotonic acid, itaconic acid or fumaric acid, maleic acid, ethylenically unsaturated carbonitriles, preferably acrylonitrile; monoesters and diesters of fumaric acid and maleic acid such as the diethyl and diisopropyl esters, and also maleic anhydride, ethylenically unsaturated sulfonic acids and salts thereof, preferably vinylsulfonic acid, 2-acrylamido-2-methylpropanesulfonic acid.

The base polymers preferably have glass transition temperatures Tg of ≦35° C., more preferably of −40 to 35° C.

Examples of preferred base polymers are vinyl ester homopolymers or copolymers of two or more vinyl esters, copolymers of one or more vinyl esters with ethylene, copolymers of one or more vinyl esters with one or more methacrylic esters or acrylic esters and optionally ethylene, copolymers of one or more vinyl esters with vinyl chloride and optionally ethylene.

Particularly preferred are vinyl acetate homopolymers; copolymers of vinyl acetate with 8% to 60% by weight of ethylene; copolymers of vinyl acetate with 1% to 60% by weight of one or more further vinyl esters, different from vinyl acetate, and optionally 5% to 60% by weight of ethylene; copolymers of vinyl acetate with 1% to 45% by weight of one or more methacrylic esters or acrylic esters and optionally 5% to 60% by weight of ethylene; the polymers may in each case also comprise the stated auxiliary monomers in the stated amounts, and the amounts in % by weight add up to 100% by weight in each case.

The monomer selection and the selection of the weight fractions of the comonomers for the carboxyl-functional polymers and for the polyvinyl esters are made such as to result in general in a glass transition temperature Tg of −50° C. to +50° C., preferably −30° C. to +40° C. The glass transition temperature Tg of the polymers can be determined in a known way by means of differential scanning calorimetry (DSC). The Tg may also be calculated approximately in advance by means of the Fox equation. According to Fox T. G., Bull. Am. Physics Soc. 1, 3, page 123 (1956), it holds that: 1/Tg=x1/Tg1+x2/Tg2+ . . . +xn/Tgn, where xn is the mass fraction (% by weight/100) of the monomer n, and Tgn is the glass transition temperature, in kelvins, of the homopolymer of the monomer n. Tg values for homopolymers are listed in Polymer Handbook 2nd edition, J. Wiley & Sons, New York (1975).

The protective colloids can be prepared by means of solution polymerization, suspension polymerization or, preferably, emulsion polymerization of the monomers a) and b). Polymerization therefore takes place preferably in aqueous medium. The polymerization temperature is preferably between 40° C. and 100° C., more preferably between 60° C. and 90° C. The polymerization takes place preferably at pH levels of 2 to 7, more preferably at 3 to 5, and can be brought about with the customary organic or inorganic acids, bases or buffers, such as, for example, phosphoric acid, carbonic acid, carboxylic acids or ammonia or salts thereof. In the case of the copolymerization of gaseous monomers such as ethylene, 1,3-butadiene or vinyl chloride, it is also possible to operate under pressure, generally at between 5 bar and 100 bar.

The polymerization is initiated using the water-soluble or monomer-soluble initiators, or redox initiator combinations, that are customary for emulsion polymerization or suspension polymerization. Examples of water-soluble initiators are the sodium, potassium and ammonium salts of peroxodisulfuric acid, hydrogen peroxide, t-butyl peroxide, t-butyl hydroperoxide, potassium peroxodiphosphate, tert-butyl peroxopivalate, cumene hydroperoxide, isopropylbenzene monohydro-peroxide, azobisisobutyronitrile. Examples of monomer soluble initiators are dicetyl peroxydicarbonate, dicyclohexyl peroxydicarbonate, dibenzoyl peroxide. The stated initiators are used in general in an amount of 0.001% to 0.02%, preferably 0.001% to 0.01%, by weight, based in each case on the total weight of the monomers.

As redox initiators, combinations are used of the stated initiators and reducing agents. Suitable reducing agents are the sulfites and bisulfites of the alkali metals and of ammonium, an example being sodium sulfite, the derivatives of sulfoxylic acid such as zinc or alkali metal formaldehyde sulfoxylates, an example being sodium hydroxymethanesulfinate, and ascorbic acid. The amount of reducing agent is generally 0.001% to 0.03%, preferably 0.001% to 0.015%, by weight, based in each case on the total weight of the monomers.

To control the molecular weight it is possible to use regulator substances during the polymerization. If regulators are used, they are employed typically in amounts between 0.01% to 5.0% by weight, preferably 0.1% to 2% by weight, based on the monomers to be polymerized, and are metered in separately or else as a premix with reaction components. Examples of such substances are n-dodecyl mercaptan, tert-dodecyl mercaptan, mercaptopropionic acid, methyl mercaptopropionate, isopropanol, and acetaldehyde.

Polymerization takes place generally in the presence of emulsifiers. It is usual to use 0.5% to 5% by weight of emulsifiers, based on the monomer amount. Suitable emulsifiers are anionic, cationic, and nonionic emulsifiers, examples being anionic surfactants, such as alkyl sulfates having a chain length of 8 to 18 C atoms, alkyl or alkylaryl ether sulfates having 8 to 18 C atoms in the hydrophobic radical and up to 40 ethylene oxide or propylene oxide units, alkyl- or alkylarylsulfonates having 8 to 18 C atoms, esters and monoesters of sulfosuccinic acid with monohydric alcohols or alkylphenols, or nonionic surfactants such as alkyl polyglycol ethers or alkylaryl polyglycol ethers having 8 to 40 ethylene oxide units.

The polymerization can be carried out with all or certain constituents of the reaction mixture included in the initial charge, or with some of all or individual constituents of the reaction mixture being included in the initial charge and some being metered in subsequently, or by the metering method without initial charge. A preferred procedure is to include a portion of the monomers a), of the monomers b), and a portion of the water and regulator and initiator in the initial charge and to meter in the remaining amount of monomer a), monomer b), regulator, initiator, and water where appropriate. If a batch process is carried out, all of the monomers, water and regulator, and a portion of the initiator, are included in the initial charge, and the remaining initiator is metered in or added in portions.

After the end of the polymerization, residual monomers can be removed using known methods of postpolymerization, generally by means of postpolymerization initiated with redox catalyst. Volatile residual monomers can also be removed by means of distillation, preferably under reduced pressure, and optionally with inert entraining gases such as air, nitrogen or steam being passed through or over the product.

The aqueous dispersions obtainable in this way have a solids content of 30% to 75% by weight. The dispersions are preferably diluted with addition of water to 10% to 25% by weight. Adjustment to a pH of between 8 and 9 takes place preferably with a base, preferably gaseous or aqueous ammonia, and usually produces clear solutions. The resulting solutions have Höppler viscosities of preferably 20 to 5000 mPas, more preferably 300 to 1000 mPas (Happier method at 20° C., DIN 53015).

The protective colloids in the form of aqueous dispersions or aqueous solutions can be dried by common techniques, such as for example by means of fluid-bed drying, freeze-drying, roll dryers or spray-drying. The dispersions are preferably spray-dried. This spray-drying takes place in customary spray-drying units, with atomization taking place by means of single-fluid, two-fluid or multifluid nozzles or with a rotating disk. The emergence temperature selected is generally in the range from 45° C. to 120° C., preferably 60° C. to 90° C., depending on the unit, resin Tg, and desired degree of drying.

The base polymers are prepared in aqueous medium and preferably by the emulsion or suspension polymerization process—as described in DE-A 102006007282, for example. The base polymers are in this case obtained in the form of aqueous dispersions. For the polymerization it is possible to use the common protective colloids and/or emulsifiers, as described in DE-A 102006007282. Preferred protective colloids are the protective colloids of the invention or partially hydrolyzed or fully hydrolyzed polyvinyl alcohols having a degree of hydrolysis of 80 to 100 mol %, especially partially hydrolyzed polyvinyl alcohols having a degree of hydrolysis of 80 to 94 mol % and a Höppler viscosity, in 4% strength aqueous solution, of 1 to 30 mPas (Höppler method at 20° C., DIN 53015). The stated polyvinyl alcohols are obtainable by means of methods known to the skilled person. The protective colloids are added generally in an amount totaling 1% to 20% by weight, based on the total weight of the monomers, in the polymerization.

The base polymers in the form of aqueous dispersions can be converted into powders by common drying techniques. In that case, in general, a drying aid is used in a total amount of 3% to 30%, preferably 5% to 20%, by weight, based on the polymeric constituents of the dispersion. Preferred drying aids are the aforesaid polyvinyl alcohols and the protective colloids of the invention.

Alternatively, the protective colloids of the invention may be applied, as for example by means of fluid-bed drying, to the base polymers in the form of their powders.

To prepare the protective colloid-stabilized polymers in the form of their dispersions, the protective colloid-stabilized polymers can be redispersed, in the form of their powders, in water. Alternatively, the protective colloids of the invention can be mixed, in the form of their aqueous dispersions or solutions, with the base polymers in the form of their aqueous dispersions or water-redispersible powders. In a further alternative procedure, the base polymers in the form of their aqueous dispersions may be mixed with the protective colloids of the invention in the form of their powders.

The average particle diameter of the protective colloid-stabilized polymers in the form of their powders is preferably between 0.1 and 500 micrometers, more preferably between 1 and 200 micrometers (Coulter determination).

The invention further provides radically crosslinkable polymer compositions comprising one or more radically crosslinkable polymers, one or more ethylenically unsaturated monomers (reactive monomers), and optionally initiators, optionally fillers, and optionally further additions, characterized in that additionally one or more protective colloid-stabilized polymers of the invention are present.

Suitable and preferred reactive monomers are the same monomers also suitable and preferred, respectively, for the polymerization for preparing the base polymers. Particularly preferred reactive monomers are styrene, methyl methacrylate, methyl acrylate, and butyl acrylate. The most preferred reactive monomer is styrene.

Preferred radically crosslinkable polymers are unsaturated polyester resins or vinyl ester resins.

The unsaturated polyester resins are reaction products of one or more dicarboxylic acids or of one or more dicarboxylic anhydrides with one or more polyols. The preparation of unsaturated polyester resins is known to the skilled person.

Vinyl ester resins are reaction products formed by polyaddition reactions or esterification reactions of phenol derivatives and ethylenically unsaturated monocarboxylic or dicarboxylic acids or dicarboxylic anhydrides having 3 to 20 carbon atoms, such as acrylic acids or methacrylic acids, for example. Preferred phenol derivatives are bisphenol A and phenol novolak. The preparation of vinyl ester resins is known to the skilled person.

Suitable initiators for the radically crosslinkable polymer compositions are, for example, t-butyl perbenzoate, t-butyl peroxy-2-ethylhexanoate, t-butyl peroxypivalate, t-butyl peroxyneodecanoate, dibenzoyl peroxide, t-amyl peroxypivalate, di(2-ethylhexyl) peroxydicarbonate, 1,1-bis(t-butylperoxy)-3,3,5-trimethylcyclohexane, di(4-t-butylcyclohexyl)peroxy-dicarbonate, azobisisobutyronitrile or photoinitiators such as benzophenone, isopropylthioxanthone, benzils (1,2 diketones), hydroxyalkylketones, α-aminoketones, benzil ketals.

Suitable fillers are, for example, talc, aluminum hydroxide, kaolin, calcium carbonate, dolomite, glass beads or glass fibers, quartz, aluminum oxide or barium sulfate.

The radically crosslinkable polymer compositions comprise preferably 30 to 60 parts by weight of radically crosslinkable polymers, 5 to 40 parts by weight of protective colloid-stabilized polymers of the invention, 30 to 160 parts by weight of reactive monomers, optionally 0.5 to 2 parts by weight of initiators, optionally fillers such as 50 to 350 parts by weight of calcium carbonate, reinforcing materials, such as 25 to 450 parts by weight of glass fibers, aramid fibers, carbon fibers, optionally further additives, such as 0.5 to 3 parts by weight of mold release agents, for example zinc stearate, and also, optionally, further adjuvants, examples being pigments, thickeners, flame retardants.

The radically crosslinkable polymer compositions are obtainable by mixing of one or more radically crosslinkable polymers, one or more ethylenically unsaturated monomers (reactive monomers), and optionally of initiators, optionally of fillers, optionally of reinforcing materials, and optionally of further additions, characterized in that additionally one or more protective colloid-stabilized polymers in the form of their powders are admixed.

The protective colloid-stabilized polymers in the form of their powders can be mixed in any desired way with the other components of the radically crosslinkable polymer compositions. For example, the protective colloid-stabilized polymers may be dissolved, emulsified or dispersed in reactive monomers and mixed in this form with the other components of the radically crosslinkable polymer compositions. The protective colloid-stabilized polymers are preferably mixed with the radically crosslinkable polymers, the reactive monomers, and optionally further liquid or dissolved components of the radically crosslinkable polymer compositions, and mixed subsequently with the remaining components of the radically crosslinkable polymer compositions, such as fillers and reinforcing materials. Alternatively it is also possible first to prepare a liquid paste from radically crosslinkable polymers, reactive monomers, and optionally further components of the radically crosslinkable polymer compositions, and then to add protective colloid-stabilized polymers and also, where appropriate, the remaining amounts of the remaining constituents of the radically crosslinkable polymer compositions.

The mixing of the components for preparing the radically crosslinkable polymer compositions may be carried out using the commonplace devices known to the skilled person, such as, for example, reactors, stirred tanks or mixers, and stirrers, such as paddle, anchor or blade stirrers, for example.

The invention further provides composite components obtainable by curing the radically crosslinkable polymer compositions of the invention.

The radically crosslinkable polymer compositions are cured preferably at temperatures of 0° C., more preferably of 20 to 200° C., and most preferably of 20 to 165° C. Curing takes place preferably in the presence of one or more initiators, by radically initiated polymerization. If desired, the radically crosslinkable polymer compositions are pressed in the course of curing at the respective temperature, with application of pressures of ≧1 mbar, more preferably of 1 to 200 000 mbar, and most preferably of 1000 to 200 000 mbar.

The composite components can be obtained from the radically crosslinkable polymer compositions by all commonplace production methods, as for example by means of the sheet molding compound (SMC) technology, bulk molding compound (BMC) technology, resin transfer molding (RTM) or resin injection molding (RIM).

The composite components are produced preferably by means of the BMC (bulk molding compound) or SMC (sheet molding compound) technique.

In the case of the BMC process, the solutions of the radically crosslinkable polymers in reactive monomer, and the protective colloid-stabilized polymers in the form of their powders, and optionally the further components such as the initiator, filler, mold release agent or further polymers, low-profile additives or adjuvants, are mixed to a pastelike mass, after which glass fibers, if desired, are admixed, and then the resultant radically crosslinkable polymer compositions are cured, with application of pressure and temperature, to form the composite component. This technique is used for example to produce reflectors for automobile headlights.

In the case of the SMC process, in a similar way to the BMC process, a pastelike mass is produced from styrenic polyester resin solution, protective colloid-stabilized polymers in the form of their powders, crosslinking catalyst, filler, mold release agent, and any further adjuvants, and this paste is applied to two carrier films. Thereafter, chopped glass fiber rovings are scattered onto one of the two layers, and finally both carrier films are united with one another, and so the layers produced come into mutual contact. Compacting then takes place by means of a system of rollers. The resulting sheetlike SMC compound is then rolled up and stored under defined conditions for at least three days, this being referred to as maturing. Finally, the sheetlike sandwich is removed from the film, cut into pieces, and pressed to moldings with application of pressure and temperature. Moldings produced by means of this technique are used, for example, as automobile tailgates.

The protective colloid-stabilized polymers of the invention in the form of their powders are free-flowing and blocking-resistant and can easily be incorporated into radically curable polymer compositions. Polymers in the form of solid resins, in contrast, are generally tacky and have a tendency to undergo blocking. When used as LPAs, the protective colloid-stabilized polymers of the invention lead to very good antishrinkage properties and also to very effective pigmentability of the composite components. Furthermore, the protective colloid-stabilized polymers in the form of their powders are storage-stable and can be dissolved, emulsified or dispersed rapidly. In this respect as well the LPAs of the invention are superior to the LPAs in the form of solid resins or exclusively polyvinyl alcohol-stabilized polymers, such as polyvinyl esters. Composite components produced in accordance with the invention have a low hydrophilicity and exhibit no tendency to absorb water, a fact which also has positive consequences for the aging stability of the composite components. This effect is also manifested in particular by comparison with corresponding composite components which comprise exclusively polyvinyl alcohol-stabilized polyvinyl esters as LPAs.

The examples below serve for further elucidation of the invention, without in any way restricting said invention.

### Preparation of Protective Colloid 1:

In a 3-liter three-neck flask, equipped with a reflux condenser and anchor stirrer, 5.2 g of sodium lauryl sulfate were dissolved in 1400 g of deionized water. Thereafter 1.54 g of potassium peroxodisulfate, 3.7 g of ammonia solution (12.5% in water) and 250 g of metered feed 1 were introduced and the batch was heated to 75° C. with stirring (rotary speed 150 rpm) in a nitrogen atmosphere.

30 minutes after 75° C. was reached, the addition was commenced of the remaining part of metered feed 1, over a period of 2 hours, and, at a separate location, of metered feed 2, over a period of 2.5 hours.

After the end of the addition of metered feed 2, polymerization was continued at 85° C. for 2 hours more. After it had cooled to room temperature, the dispersion was transferred to a 10-liter container and diluted with deionized water, with stirring, and the pH was adjusted to 8.5 with an ammonia solution (12% in water), thereby finally giving a solution having a solids content of 20% by weight. The glass transition temperature Tg of the resulting protective colloid was 70° C.

### Metered Feed 1:

| | |
|---|---|
| Methacrylic acid | 102.9 g |
| n-Butyl acrylate | 411.4 g |
| Methyl methacrylate | 514.3 g |
| Dodecyl mercaptan | 10.3 g |

### Metered Feed 2:

| | |
|---|---|
| Water | 163.0 g |
| Potassium peroxodisulfate | 1.54 g |

Base Polymers in the Form of their Aqueous Dispersions:

### Polymer Dispersion 1:

Aqueous dispersion of a vinyl acetate homopolymer having a solids content of 55% and a glass transition temperature Tg of 32° C., containing 1% by weight of Genapol LRO (alkyl polyglycol ether sulfate; trade name of Clariant) and 1% by weight of Genapol PF 40 (block copolymer based on ethylene oxide and propylene oxide; trade name of Clariant), the amounts in % by weight being based in each case on the total mass of the homopolymer.

### Polymer Dispersion 2:

Aqueous dispersion of a copolymer based on 80% by weight of vinyl acetate and 20% by weight of ethylene, having a solids content of 54% and a glass transition temperature Tg of −7° C., containing 1% by weight of Genapol LRO and 1% by weight of Genapol PF 40, the amounts in % by weight being based in each case on the total mass of the copolymer.

### Polymer Dispersion 3:

Aqueous dispersion of a copolymer based on 90% by weight of vinyl acetate and 10% by weight of VeoVa10, having a solids content of 55% and a glass transition temperature Tg of 34° C., containing 1% by weight of Genapol LRO and 1% by weight of Genapol PF 40, the amounts in % by weight being based in each case on the total mass of the copolymer.

Preparation of the Protective Colloid-Stabilized Polymers in the Form of their Powders:

### LPA-1:

Polymer dispersion 1 and protective colloid 1 were mixed such that the ratio of protective colloid 1 to polymer dispersion 1 (solid/solid) was 4:1. Additional water was added in an amount sufficient to give the dispersion, finally, a viscosity of 300 mPa·s.

The spray-drying of the dispersion took place in a spray-drying unit (single-fluid nozzles). The emergence temperature was 65° C.

A free-flowing powder was obtained with an average particle size of 120 micrometers (Coulter determination using the Beckman-Coulter LS100Q instrument).

### LPA-2:

In analogy to LPA-1, with the difference that in place of polymer dispersion 1, polymer dispersion 2 was used.

### LPA-3:

In analogy to LPA-1, with the difference that in place of polymer dispersion 1, polymer dispersion 3 was used.

### C-LPA-4:

In analogy to LPA-2, with the difference that instead of protective colloid 1, a polyvinyl alcohol (degree of hydrolysis of 88 mol % and Höppler viscosity of 5 mPa·s) was added as protective colloid.

### Production of the Composite Components:

First of all, the components listed in table 1, apart from glass fibers and filler (calcium carbonate (Millicarb)), were premixed using a dissolver in a container for 2 minutes (resin paste). This resin paste was subsequently mixed in a small laboratory kneading apparatus with the glass fibers and calcium carbonate. The kneading time here was varied between 5 and 20 minutes.

The completed bulk molding compound (BMC) was packed in such a way as to prevent styrene leakage, and stored for 2 days (maturing time).

The BMC was then introduced into a Wickert press (pressing conditions: 3 minutes, 160° C., 730 KN pressing force, 3 mm sheet thickness).

TABLE 1
Radically crosslinkable polymer compositions:

| | CEx. 1 | Ex. 2 | Ex. 3 | Ex. 4 | CEx. 5 |
|---|---|---|---|---|---|
| Components | [g] | [g] | [g] | [g] | [g] |
| Palapreg P 18-21 (UP | 62.5 | 62.5 | 62.5 | 62.5 | 62.5 |
| resin)^{a)} | | | | | |
| CC carbon black 9257-45 | 10 | 10 | 10 | 10 | 10 |
| (pigment) | | | | | |
| LPA-1 | | 5 | | | |
| LPA-2 | | | 5 | | |
| LPA-3 | | | | 5 | |
| C-LPA-4 | | | | | 5 |
| Styrene | 24.38 | 18 | 18 | 18 | 18 |
| Peroxide (Trigonox C) | 1 | 1 | 1 | 1 | 1 |
| Peroxide (Trigonox 21) | 0.5 | 0.5 | 0.5 | 0.5 | 0.5 |
| BYK 9010 additive | 0.5 | 0.5 | 0.5 | 0.5 | 0.5 |
| Luvato MK 35 (catalyst) | 3 | 3 | 3 | 3 | 3 |
| Ca stearate (lubricant) | 4 | 4 | 4 | 4 | 4 |
| p-Hydroquinone | 0.3 | 0.3 | 0.3 | 0.3 | 0.3 |
| (inhibitor) | | | | | |
| (10% in MMA)^{b)} | | | | | |
| Millicarb OG (filler) | 300 | 300 | 300 | 300 | 300 |
| Hydroquinone (stabilizer) | 0.03 | 0.03 | 0.03 | 0.03 | 0.03 |
| Owens Corning 163D- | 45 | 45 | 45 | 45 | 45 |
| 14C (4 mm length) | | | | | |
| (glass fiber) | | | | | |
| Total | 451.2 | 449.8 | 449.8 | 449.8 | 449.8 |
| Amount of LPA: | 0.0% | 1.1% | 1.1% | 1.1% | 1.1% |
| LPA/total weight | | | | | |

^{a)}Trade name of DSM;
^{b})MMA = methyl methacrylate.

The resultant black-pigmented sheets were cooled to room temperature and subsequently tested as follows:
The mechanical properties were determined in accordance with DIN EN ISO 1425
Shrinkage values (linear shrinkage): volume change determined in percent values. Minus values indicate that the composite component was larger than the original mold.
The pigmentation was determined according to optical assessment criteria (−=marbling effect, uneven pigment distribution; +++=homogeneous distribution of the pigments, uniform colored appearance; the assessments with + and ++ indicate corresponding states in-between).

The results of the testing are set out in table 2.

Comparative example 1 (without LPA) does show only a slight marbling effect; however, owing to the high shrinkage, the surface has severe defects and unevennesses. Example 2, in contrast, exhibits low shrinkage. Further improvements were achieved with examples 3 and 4. The LPA of comparative example 5 was characterized by a slow dispersing rate in styrene. In the case of the experiment with comparative example 5, with a dispersing time of 5 minutes, a composite component was observed which has very poor surface quality, uneven pigmentation, and relatively high shrinkage.

In contrast, the inventive LPAs 1-3 exhibit a considerably higher dispersing rate in styrene, and thus develop their full activity as LPAs in a time-economical way.

TABLE 2
Testing of the composite components:

| Properties | CEx. 1 | Ex. 2 | Ex. 3 | Ex. 4 | CEx. 5 | |
|---|---|---|---|---|---|---|
| Kneading time | 5 min | 5 min | 5 min | 5 min | 5 min | 15 min |
| Linear | 0.50 | 0.13 | 0.10 | 0.11 | 0.18 | 0.13 |
| shrinkage [%] | | | | | | |
| Pigmentability | + | + | +++ | ++ | − | ++ |
| Elasticity | 12 584 | 14 219 | 13 602 | 14 244 | 12 990 | 13 631 |
| modulus DIN EN | | | | | | |
| ISO 1425 [Mpa] | | | | | | |

1. A composition comprising a protective colloid-stabilized polymer as a low-profile additive (LPA), wherein the protective colloid is obtainable by radically initiated polymerization of
a) one or more ethylenically unsaturated monomers having one or more additional functional groups selected from the group consisting of carboxyl, sulfate, sulfonate, phosphate, phosphonate, hydroxyl and nitrogen functional groups and optionally
b) one or more ethylenically unsaturated monomers different from the monomers a),
with the proviso that the mass fraction of the hydroxyl groups is ≦10% by weight, based on the total mass of a protective colloid.

2. (canceled)

3. The composition as claimed in claim 1, wherein the monomers a) are selected from the group consisting of ethylenically unsaturated carboxylic acids or salts thereof, monoesters of fumaric acid or maleic acid or salts thereof, ethylenically unsaturated sulfonic acids or salts thereof, and ethylenically unsaturated phosphonic acids or salts thereof.

4. The composition as claimed in claim 1, wherein the protective colloid comprises the monomers a) at 2% to 20% by weight, based on the total mass of the protective colloid.

5. The composition as claimed in claim 1, wherein the monomers b) are selected from the group consisting of vinyl esters of carboxylic acids having 1 to 15 C atoms, methacrylic esters or acrylic esters of carboxylic acids with unbranched or branched alcohols having 1 to 15 C atoms, vinylaromatics, vinyl halides, dienes, and non-ethylene olefins.

6. The composition as claimed in claim 1, wherein monomers b) used are one or more monomers b1) selected from the group consisting of butyl acrylate, butyl methacrylate, 2-ethylhexyl acrylate, and vinyl esters of alpha-branched monocarboxylic acids having 5 to 13 C atoms, and one or more monomers b2) selected from the group consisting of methyl acrylate, methyl methacrylate, styrene, and methylstyrene.

7. The composition as claimed in claim 6, wherein the protective colloid comprises the monomers b1) at 10% to 65% by weight, based on the total mass of the protective colloid.

8. The composition as claimed in claim 6, wherein the protective colloid comprises the monomers b2) at 15% to 88% by weight, based on the total mass of the protective colloid.

9. The composition as claimed in claim 1, wherein the protective colloid has a glass transition temperature Tg of at least 25° C.

10. The composition as claimed in claim 1, wherein the polymer (base polymer) is obtainable by radically initiated polymerization of
one or more ethylenically unsaturated monomers c) selected from the group consisting of vinyl esters of carboxylic acids having 1 to 15 C atoms, methacrylic esters or acrylic esters of carboxylic acids with unbranched or branched alcohols having 1 to 15 C atoms, vinylaromatics, vinyl halides, dienes, and olefins.

11. The composition as claimed in claim 1, wherein the protective colloid-stabilized polymer has an average particle diameter of 0.1 to 500 micrometers (Coulter determination).

12. A radically crosslinkable polymer composition comprising one or more radically crosslinkable polymers, one or more ethylenically unsaturated monomers (reactive monomers), and optionally initiators, optionally fillers, and optionally further additions, wherein
additionally one or more protective colloid-stabilized polymers as claimed in claim 1 are present.

13. A composite component obtainable by curing the radically crosslinkable polymer composition as claimed in claim 12.
